(19) United States
(12) Patent Application Publication
(10) Pub. No.: US 2025/0355707 A1
(43) Pub. Date: Nov. 20, 2025

(54) FORWARD LOOKING RESOURCE MANAGER

(71) Applicant: The Toronto-Dominion Bank, Toronto (CA)

(72) Inventor: Breena Patricia GORMLEY, Toronto (CA)

(73) Assignee: The Toronto-Dominion Bank, Toronto (CA)

(21) Appl. No.: 18/663,481

(22) Filed: May 14, 2024

(51) Int. Cl. G06F 9/50; G06F 11/30

(52) U.S. Cl. CPC G06F 9/5016; G06F 11/3034

(57) ABSTRACT

There is provided a computer system configured determine one or more parameters of a deterioration condition at a future point in time and transfer a token between two logical storage areas based on the one or more parameters, the token including data that enables the computer system to perform a computing operation in association with one of the two logical storage areas that comprises the token. The computer system is further configured to monitor for occurrence of the deterioration condition; and, in response to detecting the occurrence of the deterioration condition, reverse a direction of the transfer of the token to enable the computer system to perform the computing operation in association with the other one of the two logical storage areas that now comprises the token. The computer system may be configured to analyze data in connection with a first logical storage area using a trained machine learning model.

### TECHNICAL FIELD

The present application relates to resource management and, more particularly, to systems and methods for moving resources in a networked computing environment.

### BACKGROUND

Individuals often find it difficult to adapt to changes in their resources. The variations in resources may result from a variety of personal and/or external circumstances, which may cause changes to the inflow (receiving) and/or the outflow (using) of the resources over time. These variations or inconsistencies may be difficult and laborious for an individual to monitor, keep track of, and plan ahead for. With inadequate planning for the future shortage, an individual may attempt to use or perform computer operations with insufficient resources. Such attempts often fail, wasting the resources used in the attempt and often requiring further resources to make-up for the failed attempt, the further resources being in addition to that which would have been used if sufficient resources were available in the first place.

### BRIEF DESCRIPTION OF THE DRAWINGS

Embodiments are described in detail below, with reference to the following drawings:

FIG. 1 is a schematic operations diagram illustrating an operating environment of a system according to an example embodiment of the present disclosure;

FIG. 2 is a simplified schematic diagram showing components of a client device of FIG. 1;

FIG. 3 is a high-level schematic diagram of an example computer system;

FIG. 4 shows a simplified organization of software components stored in a memory of the computer system of FIG. 3;

FIG. 5 is a schematic diagram illustrating a components of the computer system and the database of FIG. 1 according to example embodiments; and

FIG. 6 is a flowchart showing operations performed by the computer system of FIG. 5 for generating summaries about the context of data transfers according to example embodiments.

Like reference numerals are used in the drawings to denote like elements and features.

### SUMMARY

In one aspect of the present disclosure, there is provided a computer system comprising: a processor; a memory coupled to the processor, the memory storing computer-executable instructions that, when executed by the processor, configure the processor to: determine one or more parameters of a deterioration condition at a future point in time; transfer a token between two logical storage areas based on the one or more parameters, the token including data that enables the computer system to perform a computing operation in association with one of the two logical storage areas that comprises the token; monitor for occurrence of the deterioration condition; and in response to detecting the occurrence of the deterioration condition, reverse a direction of the transfer of the token to enable the computer system to perform the computing operation in association with the other one of the two logical storage areas that now comprises the token.

In some implementations, the two logical storage areas comprise a first logical storage area and a second logical storage area, the deterioration condition being associated with the first logical storage area, and wherein the transfer occurs from the first logical storage area to the second logical storage area, and the reversed transfer occurs from the second logical storage area to the first logical storage area.

In some implementations, the deterioration condition includes one or more of: a decrease in input of a resource into the first logical storage area; and an increase in use of the resource in the first logical storage area.

In some implementations, the one or more parameters of the deterioration condition include one or more of an expected resource shortage amount in the first logical storage area upon the occurrence of the deterioration condition, an expected period of time until the occurrence of the deterioration condition, and an expected duration of the deterioration condition.

In some implementations, the instructions, when executed by the processor, further configure the processor to configure the token to represent an amount of the resource based on the one or more parameters.

In some implementations, the instructions, when executed by the processor, further configure the processor to: periodically transfer further tokens from the first logical storage area to the second logical storage area based on the one or more parameters, the further tokens including data that enables the computer system to perform computing operation in association with the second logical storage area that comprises the further tokens; and in response to detecting the occurrence of the deterioration condition, reverse the transfer of the tokens to enable the computer system to perform the computing operations in association with the first logical storage area that comprises the tokens.

In some implementations, the instructions, when executed by the processor, further configure the processor to: configure the token and the further tokens to collectively represent the expected resource shortage amount.

In some implementations, the instructions, when executed by the processor, configure the processor to determine the one or more parameters of the deterioration condition by analyzing historical data in connection with the first logical storage area.

In some implementations, the instructions, when executed by the processor, further configure the processor to analyze the historical data in connection with the first logical storage area using a trained machine learning model.

In some implementations, the instructions, when executed by the processor, configure the processor to determine the one or more parameters of the deterioration condition by receiving information regarding the deterioration condition.

In some implementations, the instructions, when executed by the processor, further configure the processor to determine the one or more parameters of the deterioration condition by consulting third-party data based on the received information.

In some implementations, the received information input is contained within a document associated with the deterioration condition, and the instructions, when executed by the processor, configure the processor to analyse the document to determine the one or more parameters.

In some implementations, the instructions, when executed by the processor, further configure the processor to analyse the document to obtain the received information using a trained machine learning model.

In some implementations, the instructions, when executed by the processor, further configure the processor to: in response to detecting the occurrence of the deterioration condition, reconfigure each token to represent another amount of the resource based on the one or more parameters.

In some implementations, the instructions, when executed by the processor, further configure the processor to obtain approval for the one or more parameters of the deterioration condition and/or for the transfer of the token between the two logical storage areas prior to the transfer.

In another aspect of the present disclosure, there is provided a computer-implemented method comprising: determining one or more parameters of a deterioration condition at a future point in time; transferring a token between two logical storage areas based on the one or more parameters, the token including data that enables the computer system to perform a computing operation in association with one of the two logical storage areas that comprises the token; monitoring for occurrence of the deterioration condition; and in response to detecting the occurrence of the deterioration condition, reversing a direction of the transfer of the token to enable the computer system to perform the computing operation in association with the other one of the two logical storage areas that now comprises the token.

In some implementations, the one or more parameters of the deterioration condition include one or more of an expected shortage amount of a resource in a first logical storage area of the two logical storage areas upon the occurrence of the deterioration condition, an expected period of time until the occurrence of the deterioration condition, and an expected duration of the deterioration condition.

In some implementations, the method further comprises periodically transferring further tokens from the first logical storage area to a second logical storage area based on the one or more parameters, the further tokens including data that enables the computer system to perform computing operation in association with the second logical storage area that comprises the further tokens; and in response to detecting the occurrence of the deterioration condition, further reversing the transfer of the tokens to enable the computer system to perform the computing operations in association with the first logical storage area that now comprises the tokens.

In some implementations, the method further comprises configuring the token and the further tokens to collectively represent the expected shortage amount of the resource.

In some implementations, determining the one or more parameters of the deterioration condition comprises analyzing historical data in connection with the first logical storage area with a trained machine learning model.

In another aspect of the present disclosure, there is provided a non-transitory computer readable medium having stored thereon processor-executable instructions which, when executed by at least one processor, configure the at least one processor to: determine one or more parameters of a deterioration condition at a future point in time; transfer a token between two logical storage areas based on the one or more parameters, the token including data that enables the computer system to perform a computing operation in association with one of the two logical storage areas that comprises the token; monitor for occurrence of the deterioration condition; and in response to detecting the occurrence of the deterioration condition, reverse a direction of the transfer of the token to enable the computer system to perform the computing operation in association with the other one of the two logical storage areas that now comprises the token.

In the present application, the term “and/or” is intended to cover all possible combinations and sub-combinations of the listed elements, including any one of the listed elements alone, any sub-combination, or all of the elements, and without necessarily excluding additional elements.

Other aspects and features of the present application will be understood by those of ordinary skill in the art from a review of the following description of examples in conjunction with the accompanying figures.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

### DETAILED DESCRIPTION OF VARIOUS EMBODIMENTS

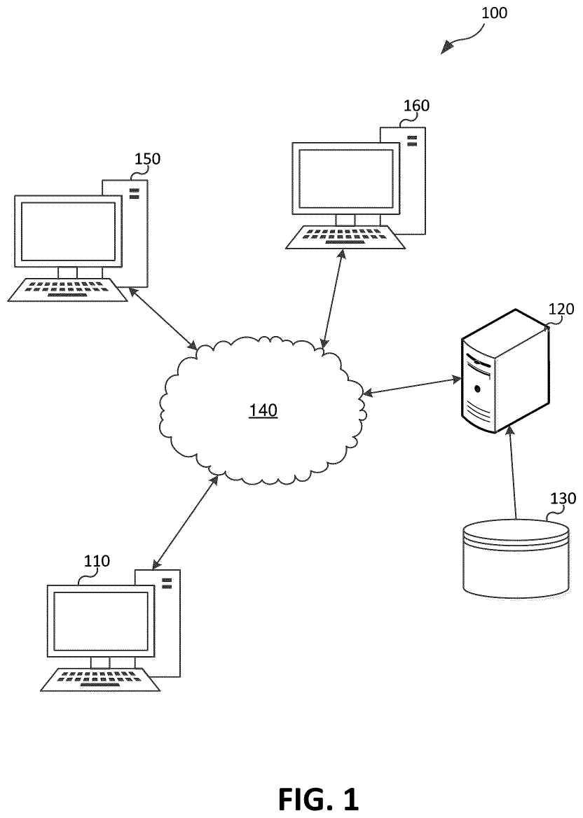

FIG. 1 is a schematic operation diagram illustrating an operating environment of an example embodiment. As shown, the system 100 includes a client device 110 and a computer system 120 with a database 130, coupled to one another through a network 140, which may include a public network such as the Internet and/or a private network. The client device 110 and the computer system 120 may be in geographically disparate locations. In other words, the client device 110 and the computer system 120 may be located remote from one another. The system 100 may optionally further include a resource provider computer system 150 and resource recipient computer system 160. These may also be coupled to the client device 110 and the computer system 120 through the network 140.

The client device 110 may be a desktop computer as shown in FIG. 1. However, the client device 110 may be a computing device of another type such as for example a smartphone, a laptop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. The client device 110 may be associated with an entity, such as a user or a client,

The computer system 120 may be, for example, a mainframe computer, a minicomputer, or the like. In some embodiments thereof, a computer system may be formed of or may include one or more computing devices. The computer system 120 may include and/or may communicate with multiple computing devices such as, for example, database servers (including a database 130), computer servers, and the like. Multiple computing devices such as these may be in communication using a computer network and may communicate to act in cooperation as a computer server system. For example, the computing devices may communicate using a local-area network (LAN). In some embodiments, the computer system 120 may include multiple computing devices organized in a tiered arrangement. For example, the computer system 120 may include middle tier and back-end computing devices. In some embodiments, the computer system 120 may be a cluster formed of a plurality of interoperating computing devices.

The database 130 may be provided internally within the computer system 120 or externally. To that end, the database 130 may be provided remotely from the computer system 120. For example, the database 130 may be stored in one or more data centers, and the data centers may store data with bank-grade security. The database 130 may include records associated with a plurality of users or entities, including the user associated with the client device 110. The records may be for a plurality of accounts and at least some of the records may define or store resources. The records may also define a quantity of resources. In some embodiments, the user that is associated with the client device 110 may be associated with an account having one or more records in the database 130. The records may reflect a quantity of stored resources that are associated with the user. Such resources may include owned resources and, in at least some embodiments, borrowed resources. The resources that are associated with a user may be grouped into various buckets.

The network 140 is a computer network. In some embodiments, the network 140 may be an internetwork such as may be formed of one or more interconnected computer networks. For example, the network 140 may be or may include an Ethernet network, an asynchronous transfer mode (ATM) network, a wireless network, a telecommunications network, or the like.

The computer system 120 may be associated with or be used by one of various institutions or merchants. In some embodiments, the computer system 120 may be associated with a merchant or vendor who provides goods and/or services (as the resource) to the user of the client device 110. The goods and/or services may be provided one-time or in a recurring manner. For example, the user of the client device 110 may have a subscription for a good and/or service with the merchant or vendor associated with the computer system 120, the good and/or service being of the type where all or a portion of the resource may be used now or stored for future use. The good and/or service may be a subscription for cloud storage space, where the user/subscriber receives a certain amount of cloud storage space to store content over a designated period of time. The user of the client device 110 may have one or more accounts with the merchant or vendor on the computer system 120 for accessing and storing the good and/or service the user is subscribed for. For example, the cloud storage subscriber may have a long-term storage account and a short-term storage account with the merchant or vendor. The cloud storage subscriber may keep a certain amount of data storage in the long-term storage account to use at a later point in time and keep the remaining data storage in a short-term storage account for immediate use. The computer system 120 may also allow the user to transfer the goods and/or services between the accounts or storage areas.

The computer system 120 may maintain records of the user's account(s) and their content, associated historical transfers, and other usage data in the database 130. In this manner, the merchant or vendor associated with the computer system 120 may be the provider of the good and/or service to the user's account(s) through the computer system 120, while the user associated with the client device 110 may be the recipient and user of the good and/or service through the client device 110.

In other embodiments, the computer system 120 may be associated with a financial institution. To that end, the financial institution may maintain records of customer financial accounts and associated financial data in the database 130. In such examples, some buckets may represent individual bank accounts. For example, a user may be associated with one or more bank accounts, such as a chequing account (for day-to-day use) and a savings account (for longer-term storage). At least some of the resources may be borrowed resources. The borrowed resources may, for example, represent an amount of credit that is available to the user. The user that is associated with the client device 110 and the account may be a customer of the financial institution which operates or manages the computer system 120.

In some embodiments, the provider and the recipient of the resources to/from the user's account(s) on the computer system 120 may be the financial institution itself or may be third-party entities. In that regard, the system 100 may further include one or more third-party computer systems, such as the resource provider computer system 150 and resource recipient computer system 160. These may also be coupled to the client device 110 and the computer system 120 through the network 140. The resource provider computer system 150 may be associated with an employer or other source of income for the user associated with the client device 110, from which the user receives (at times, recurring) deposits into one of their customer financial accounts on the computer system 120. The resource recipient computer system 160 may be associated with an entity to whom the user pays, or provides their resources to, from their customer financial accounts.

While the example shown in FIG. 1 shows the system 100 having one resource provider computer system 150 and one resource recipient computer system 160, it will be appreciated that the system 100 may include more than one resource provider computer system 150 and more than one resource recipient computer system 160.

FIG. 1 illustrates an example representation of components of the system 100. The system 100 can, however, be implemented differently than the example of FIG. 1. For example, various components that are illustrated as separate systems in FIG. 1 may be implemented on a common system. By way of further example, the functions of a single component may be divided into multiple components. In another embodiment, the system 100 may be a cloud-based system. For example, the computer system 120 may itself be virtual and the various components and modules thereof may be resident on the cloud. The computer system 120 may include one or more virtual machines or virtual processors that may be accessed via the cloud.

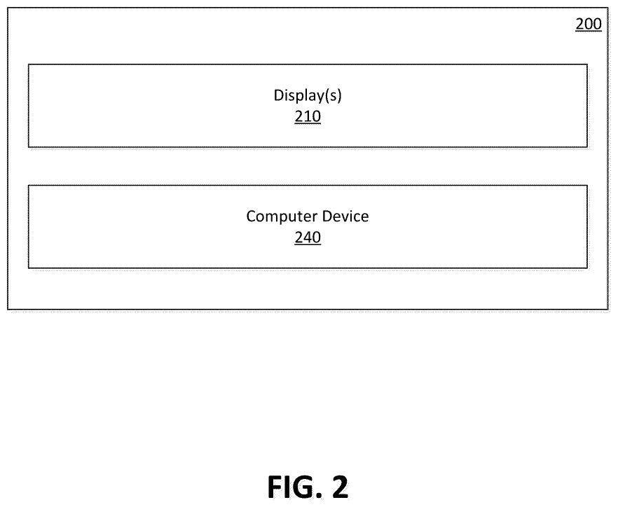

FIG. 2 is a simplified schematic diagram showing components of an exemplary computing device, such as the client device 110. The client device 110 may include modules including, as illustrated, for example, one or more displays 210 and a computer device 240.

The one or more displays 210 are a display module. The one or more displays 210 are used to display screens of a graphical user interface that may be used, for example, to communicate with the computer system 120. The one or more displays 210 may be internal displays of the client device 110 (e.g., disposed within a body of the computing device).

The computer device 240 is in communication with the one or more displays 210. The computer device 240 may be or may include a processor which is coupled to the one or more displays 210.

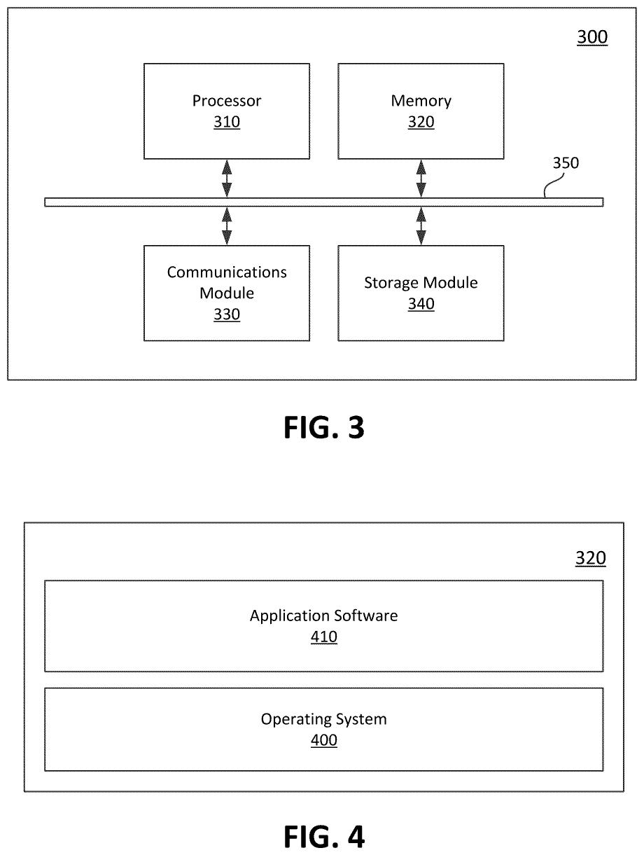

Referring now to FIG. 3, a high-level operation diagram of an example computer system 300 is shown. In some embodiments, the example computer system 300 may be exemplary of the computer system 120 and/or the client device 110 (shown in FIG. 1). The example computer system 300 includes a variety of modules. For example, the example computer system 300 may include at least one processor 310, a memory 320, a communications module 330, and/or a storage module 340. As illustrated, the foregoing example modules of the example computer system 300 are in communication over a bus 350.

The at least one processor 310 is a hardware processor. The at least one processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive, or the like. Read-only memory and persistent storage are non-transitory computer-readable storage mediums. A computer-readable medium may be organized using a file system such as may be administered by an operating system governing overall operation of the example computer system 300.

The communications module 330 allows the example computer system 300 to communicate with other computers or computing devices and/or various communications networks. For example, the communications module 330 may allow the example computer system 300 to send or receive communications signals to/from the client devices 110 over the network 140. Communications signals may be sent or received according to one or more protocols or according to one or more standards. For example, the communications module 330 may allow the example computing system 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computing system 300 to communicate using near-field communication (NFC), via Wi-Fi™, using Bluetooth™ or via some combination of one or more networks or protocols. In some embodiments, all or a portion of the communications module 330 may be integrated into a component of the example computing system 300. For example, the communications module 330 may be integrated into a communications chipset. In some embodiments, the communications module 330 may be omitted such as, for example, if sending and receiving communications is not required in a particular application.

The storage module 340 allows the example computing system 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as the database 130, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the at least one processor 310 in concert with the communications module 330 such as, for example, if data is stored remotely. The storage module may also be referred to as a data store.

Software comprising instructions is executed by the at least one processor 310 from a computer-readable medium. For example, software may be loaded into random-access memory from persistent storage of the memory 320. Additionally or alternatively, instructions may be executed by the at least one processor 310 directly from read-only memory of the memory 320.

FIG. 4 depicts a simplified organization of software components stored in the memory 320 of the example computing system 300 (FIG. 3). As illustrated, these software components include an operating system 400 and an application 410.

The operating system 400 is software. The operating system 400 allows the application 410 to access the at least one processor 310, the memory 320, and the communications module 330 of the example computing system 300 (FIG. 3). The operating system 400 may be, for example, Google™ Android™, Apple™ iOS™, UNIX™, Linux™, Microsoft™ Windows™, Apple OSX™ or the like.

The application 410 adapts the example computing system 300, in combination with the operating system 400, to operate as a device performing a particular function. For example, the application 410 may cooperate with the operating system 400 to adapt a suitable embodiment of the example computing system 300 to operate as the computing system 120 and/or the client device 110 (from FIG. 1).

While a single application 410 is illustrated in FIG. 4, in operation, the memory 320 may include more than one application 410 and different applications may perform different operations. For example, in at least some embodiments in which the example computing system 300 is functioning as the client device 110, the applications 410 may include an application for displaying a graphical user interface associated with sending an application programming interface request. The computer system 120 may be configured to receive application programming interface requests and may perform operations to respond thereto.

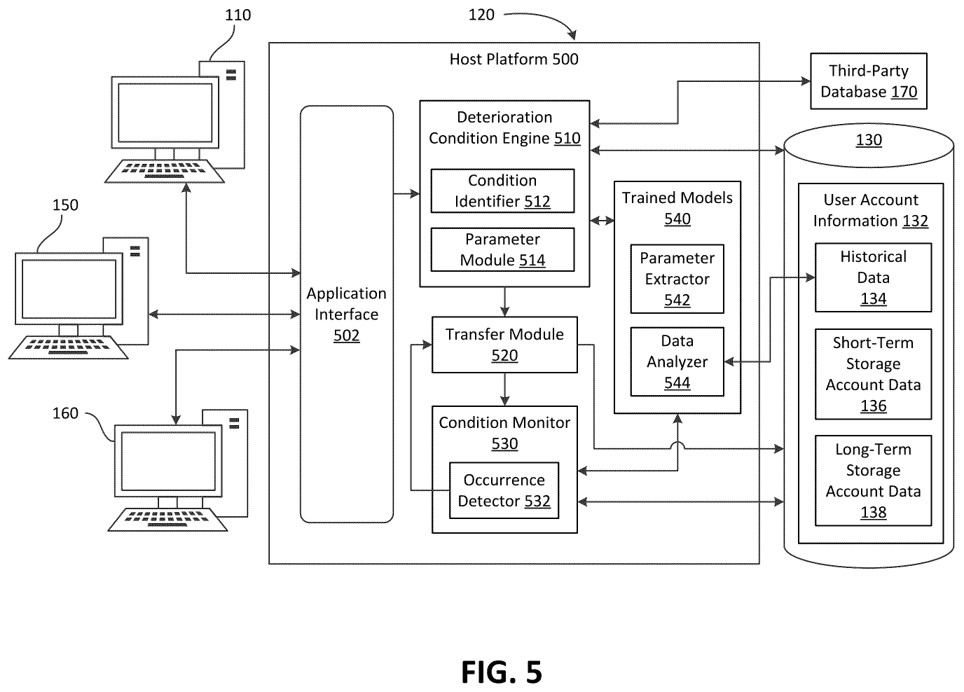

FIG. 5 is a simplified schematic diagram showing components of the memory 320 of the computer system 120 on a host platform 500 and the database 130 in greater detail.

The computer system 120 may maintain records of the user's account(s) and their content, associated historical transfers, and other usage data in the database 130. In the illustrated embodiment, the database 130 comprises the user's account information 132. As noted above, the user may have a short-term storage area/account and a long-term storage area/account with the merchant or institution associated with the computer system 120. Thus, the user's account information 132 may include, respectively, data associated with the short-term storage account 136 and data associated with the long-term storage account 138. Such data may include information regarding the current resource status and content of each account and associated details. The user's account information 132 may further include historical data 134 regarding the historical statuses and resource use of, or transfers into and out of, each account.

The computer system 120 may store computer-executable instructions in the memory 320, which may be executed by a processing unit such as the processor 310, to implement one or more embodiments disclosed herein. The depicted example embodiments are directed to the computer system 120 that hosts the host platform 500 (that may use one or more trained machine learning (ML) models), to identify a future deterioration condition in a first logical storage area, determine parameters of the future deterioration condition, configure transfer of a token to a second logical storage area based on the parameters, determine when the deterioration condition occurs, and reconfigure the transfer to reverse the transfer of the token.

The memory 320 of the computer system 120 may store instructions for implementing software applications 410 hosted by the host platform 500, including a deterioration condition engine 510, a transfer module 520, a condition monitor 530, and trained models 540.

In the depicted example, the host platform 500 may be a cloud platform, web server, etc., that hosts software applications and other software programs that are hosted and made available on the Internet to the client device 110. The software may be accessed via a URL, mobile application, etc. In other examples, the deterioration condition engine 510, the transfer module 520, and the condition monitor 530 may reside in the memory 320 of the client device 110, while the trained models 540 may reside in the memory 320 of the computer system 120. Other variations are possible.

The application interface 502 may act as a software intermediary that allows an application executing on the client device 110 to communicate with an application executing on the computer system 120. The application interface 502 may allow the client device 110 to request data and may enable the computer system 120 to obtain and provide the requested data to the client device 110. The application interface 502 may be configured to receive application programming interface requests that define parameters. The application interface 502 may perform operations to obtain data to fulfill the application programming interface requests.

In one or more embodiments, the application interface 502 may include a representational state transfer (REST) application programming interface. The REST application programming interface may utilize Hypertext Transfer Protocol (HTTP) methods (e.g. GET, POST) to receive and respond to application programming interface requests. The REST application programming interface may obtain data according to application programming interface requests and may return fixed data sets as a response to the application programming interface requests.

In one or more embodiments, the application interface 502 may include a GraphQL application programming interface. The GraphQL application programming interface may be hierarchical. The GraphQL application programming interface may obtain data according to application programming interface requests without under fetching or over fetching data.

The application interface 502 may include both the REST application programming interface and the GraphQL schemas and may perform operations to select one of the REST and GraphQL application programming interfaces. In one or more embodiments, the computer system 120 may receive an application programming interface request in a format compliant with one of the application programming interface schemas and may translate the request into another format.

A deterioration condition may be defined as a (future) circumstance that will result in a shortage of a particular resource for the user. The deterioration condition may result from a decrease in resource input and/or an increase in resource use or output for a particular storage area. A user may not be aware of such a future deterioration condition. Even if they were aware, the user may not know to, or know how to, prepare for such an occurrence. As noted above, when the deterioration condition occurs and the user attempts to use or perform operations with insufficient resources, the attempt tends to fail. This wastes the attempt resources and often requires further resources to make-up for the failed attempt in addition to that which would have been used if sufficient resources were available, resulting in an inefficient use of resources.

In that regard, the deterioration condition engine 510 comprises instructions to the processor 310 to identify a future deterioration condition (such as with a condition identifier 512), and then to determine one or more parameters associated with the identified deterioration condition (such as with a parameter module 514). The parameters associated with the identified deterioration may include one or more of an expected resource shortage amount upon the occurrence of the deterioration condition, an expected period of time from the current date until the occurrence of the deterioration condition, and an expected duration of the deterioration condition, among others. The parameters may alternatively include information or data that may be used to determine the expected resource shortage amount upon the occurrence of the deterioration condition, the expected period of time until the occurrence of the deterioration condition and/or the expected duration of the deterioration condition etc.

The user may have a first logical storage area (such as a short-term storage account) and a second logical storage area (such as a long-term storage account) with the merchant or institution associated with the computer system 120, and the shortage of the resource caused by the deterioration condition may occur in one of the two storage areas. For example, the deterioration condition may affect the resources in the first logical storage area or the short-term storage account. In that regard, the condition identifier 512 may comprise instructions to the processor 310 to identify a deterioration condition for the first logical storage area at a future point in time, and the parameter module 514 may comprise instructions to the processor 310 to determine the one or more parameters of the deterioration condition. As noted above, the deterioration condition may be a decrease in input of the resource into the first logical storage area and/or an increase in resource use from the first logical storage area.

While the condition identifier 512 and the parameter module 514 are discussed as separate components of the deterioration condition engine 510, in other implementations, they may be (and operate as) one component.

In an example implementation, the condition identifier 512 may comprise instructions to the processor 310 to identify the deterioration condition by simply receiving input from the client device 110 in the form of data or information, such as via a user interface on the client device 110, indicating that a deterioration condition is pending and what the deterioration condition will be. The parameter module 514 may, in turn, comprise instructions to the processor 310 to determine the associated parameters of the deterioration condition by receiving further information input from the client device 110, indicating what the parameters are.

In another implementation, the information from the client device 110 may be less direct and may be information or data regarding the deterioration condition. The condition identifier 512 and the parameter module 514 may comprise instructions to the processor 310 to process the received information in order to determine what the deterioration condition is and/or what the associated parameters are. Processing the received information may involve calculating the one or more parameters of the deterioration condition from the received data. For example, if the received data includes a percentage decrease in the resource starting on a future date, the condition identifier 512 may be configured to identify the future decrease as the deterioration condition and the parameter module 514 may comprise instructions to the processor 310 to calculate the expected resource shortage amount and the expected period of time until the deterioration condition from the percentage decrease, current resource amount, the future date, and the current date. Other variations are possible.

In another implementation, processing the received information/data may involve consulting an internal or third-party database based on the received data in order to determine the expected resource shortage amount and/or the expected period of time. For example, if the provider of the resource to the user's account(s) on the computer system 120 is a third-party entity, such as through the resource provider computer system 150, the deterioration condition information from the client device 110 may be regarding the user's change in status with the third-party entity. In such a case, the parameter module 514 may comprise instructions to the processor 310 to determine the expected resource shortage amount by querying the third-party entity or consulting a database of the third-party entity through the resource provider computer system 150 (such as through an application programming interface call). Alternatively, a third-party database 170 may be consulted that may be associated with a different third-party entity altogether.

In a further implementation, the input from the client device 110 may be in the form of one or more documents, and the information pertaining to the deterioration condition may be contained within the one or more documents. The condition identifier 512 and the parameter module 514 may then comprise instructions to the processor 310 to analyse the one or more documents to obtain the information pertaining to the deterioration condition, and to determine the one or more parameters from that information. To that end, the condition identifier 512 and the parameter module 514 may be or may use a software tool or a machine learning (ML) model trained to “read” the one or more documents, such as by using optical character recognition, and to obtain the relevant information pertaining to the deterioration condition therefrom.

In an example embodiment, the host platform 500 may include one or more trained machine learning models 540 which are capable of receiving inputs and generating outputs in response. The trained machine learning model(s) 540 may be held by the host platform 500 within a model repository or held and accessed remotely from a cloud. One of the trained machine learning models 540 may be a parameter extractor 542.

The parameter extractor 542 may be a ML model that has been trained to recognize text in a document and identify key information, such as key dates or rates pertaining to the deterioration condition, in the text. The parameter extractor 542 may be, for example, a trained neural network, a trained deep neural network (DNN), or a trained convolutional neural network (CNN). The parameter extractor 542 may have been trained using a training dataset of text bodies that have been labelled with ground-truth parameter data, including key information. In that manner, the parameter extractor 542 may be a large language model, such as one that uses natural language processing (NLP) techniques to extract key parameter information from the body of text. For example, the parameter extractor 542 may have been trained to extract a percentage increase in the future use of the resource, a future date of occurrence, and/or how long (i.e. the duration) the percentage increase in the future will apply for. Once extracted, the parameter module 514 may further comprise instructions to the processor 310 to process the extracted information as discussed above.

In a further implementation, the condition identifier 512 and the parameter module 514 may comprise instructions to the processor 310 to identify the deterioration condition and the associated parameters by analyzing historical data 134 in connection with the user's account(s), such as the first logical storage area or the short-term storage account. To that end, the condition identifier 512 and the parameter module 514 may directly obtain the historical data 134 from the database 130 associated with the user to identify a recurring deterioration condition that has occurred in the past and its associated parameters (such as the past resource shortage, when the past resource shortage occurred, and its duration). To that end, the condition identifier 512 and the parameter module 514 may comprise instructions to the processor 310 to compare the historical data 134 to predetermined thresholds to identify a deterioration condition and determine the one or more parameters.

Alternatively, the condition identifier 512 and the parameter module 514 may be or may use another software tool or machine learning model trained to process the historical data and determine the existence of a recurring past deterioration condition and parameters of, or relevant information pertaining to, the recurring past deterioration condition. The trained machine learning models 540 may comprise another model to that end, such as a data analyzer 544.

The data analyzer 544 may be another ML model that has been trained to process the historical data 134 (including past input/output of resources) associated with the user's account(s) and determine the existence of a past deterioration condition and parameters of, or relevant information pertaining to, the past deterioration condition. The data analyzer 544 may be, for example, a trained neural network, a trained deep neural network (DNN), or a trained convolutional neural network (CNN). The data analyzer 544 may have been trained using a training dataset of user account historical data that have been labelled with ground-truth deterioration condition and parameter data. For example, the data analyzer 544 may have been trained to identify a deterioration condition, such as a regular increase in resource use over a same/similar period of time over multiple years in relation to the same storage area. The data analyzer 544 may have been further trained to then identify one or more parameters pertaining to the deterioration condition, such as the average amount of increase in resource use within those multiple years (which may be considered the expected resource shortage amount), the average start date of the deterioration condition (which may be used to determine the expected period of time until the occurrence of the deterioration condition), and/or the average duration of the deterioration condition.

The deterioration condition engine 510 may comprise instructions for the processor to seek and receive input from the client device 110, such as via the user interface on the client device 110, regarding the deterioration condition and associated parameters, such as if they are correct, if they need modification, and what those modifications should be.

After determining the deterioration condition and associated parameters, the system 100 is then configured to transfer a token between the logical storage areas based on the one or more parameters with the transfer module 520. For present purposes, a token comprises data that enables the system 100 to perform a computing operation in association with the logical storage area (such as the first or second logical storage area) that comprises the token. The token or the data of the token may represent a particular amount of the resource. Thus, in some implementations, transferring the token between the logical storage areas may represent transferring the represented amount of the resource between the logical storage areas. A computing operation may be considered an operation that is performed by the system 100 with the resource represented by the token in the relevant storage area, such as saving a data file (if the resource is cloud storage) or purchasing a product (if the resource is money).

For example, if the deterioration condition is determined to occur in relation to the first logical storage area at a future point in time, the transfer module 520 may comprise instructions to the processor 310 to transfer a token from the first logical storage area to the second logical storage area (such as from the short-term storage account to the long-term storage account). The transfer thereby changes the data associated with the short-term storage account 136 and the data associated with the long-term storage account 138. Following the transfer of the token, the system 100 can perform the computing operation in association with the second logical storage area that is enabled by the token (where the same computer operation cannot be performed in association with the first logical storage area, as it no longer comprises the token).

Prior to the transfer, the transfer module 520 may comprises instructions to the processor 310 to configure the token based on the deterioration condition parameters, including its represented resource amount. For example, if only one token is to be transferred from the first logical storage area to the second logical storage area, the token may be configured to represent the entire expected resource shortage amount and may be configured to be transferred as soon as possible (such as, as soon as sufficient resources are present in the first logical storage area) prior to the expected date of the occurrence of the deterioration condition.

In other implementations, multiple tokens may be transferred through multiple transfers from the first logical storage area to the second logical storage area. In such cases, the transfer module 520 may comprises instructions to the processor 310 to configure multiple tokens, each token being configured to represent a portion of the expected resource shortage amount and may be configured to be transferred at periodic points of time prior to the expected date of the occurrence of the deterioration condition. The multiple tokens may collectively represent the expected resource shortage and, in some implementations, the transfer module 520 may comprises instructions to the processor 310 to transfer one of the multiple tokens into the second logical storage area at regular intervals over the expected period of time until the occurrence of the deterioration condition. As before, each transfer changes the data associated with the short-term storage account 136 and the data associated with the long-term storage account 138.

The transfer(s) may be performed automatically after the deterioration condition and its parameters are determined. Alternatively, also prior to the transfer(s), the transfer module 520 may comprise instructions for the processor to seek and receive input from the client device 110, such as via the user interface on the client device 110, regarding the parameters of the token(s), such as if user agrees or approves of the represented resource value of each token, how often they are to be transferred, when they are to be transferred etc., and if the user would like to modify the token parameters. The transfer(s) may then be performed following receipt of user approval.

The system 100 is further configured to monitor for occurrence of the deterioration condition, based on the identified deterioration condition and the determined associated parameters, such as with the condition monitor 530. The condition monitor 530 may comprise instructions to the processor 310 to monitor the factors necessary to determine whether the deterioration condition has occurred. In applications where the expected period of time until the occurrence of the deterioration condition has been determined by the deterioration condition engine 510, the condition monitor 530 may simply comprise instructions to the processor 310 to monitor for the passing of the expected period of time. In applications where the expected period of time until the occurrence of the deterioration condition depends on a particular change in the first and/or second logical storage area, the condition monitor 530 may comprise instructions to the processor 310 to monitor the activity of first and/or second logical storage area in order to identify the requisite change.

For detecting the occurrence of the deterioration condition, the condition monitor 530 may comprise an occurrence detector 532, which comprise instructions to the processor 310 to detect for the occurrence of the deterioration condition and to send a signal to the transfer module 520 indicating that the deterioration condition has been detected.

In response to the signal indicating that the occurrence of the deterioration condition has been detected, the transfer module 520 further comprises instructions to the processor 310 to reverse the direction of the transfer(s) of the token(s). This enables the system 100 to perform the computing operation in association with the other one of the two logical storage areas that now comprises the token. In the implementations where the token was initially transferred from the first logical storage area to the second logical storage area, the transfer module 520 comprises instructions to the processor 310 to reverse the transfer so the token is transferred from the second logical storage area to the first logical storage area (such as from the long-term storage account to the short-term storage account). The reversed transfer also changes the data associated with the short-term storage account 136 and the data associated with the long-term storage account 138. Following the reversed transfer of the token, the system 100 can perform the computing operation in association with the first logical storage area that is enabled by the token (where the same computer operation can no longer be performed in association with the second logical storage area, as it no longer comprises the token).

Prior to the reversed transfer, the transfer module 520 may comprise instructions to the processor 310 to further reconfigure the token, including its represented resource amount. For example, if only one token is to be transferred from the second logical storage area to the first logical storage area, the reconfigured token may be configured to represent the entire expected resource shortage amount and may be configured to be transferred on the day the deterioration condition occurrence is/was detected.

In other implementations, if multiple reconfigured tokens are to be transferred from the second logical storage area to the first logical storage area, the transfer module 520 may comprise instructions to the processor 310 to reconfigure multiple tokens, each reconfigured token being configured to represent a portion of the expected resource shortage amount and may be configured to be transferred at periodic points of time after detection of the occurrence of the deterioration condition. The represented value of each reconfigured token may be the same or different than the represented value of the original tokens.

In some implementations, the tokens may be reconfigured, and the transfers reversed automatically upon detection of the occurrence of the deterioration condition. In other implementations, prior to reversing the transfers, the transfer module 520 may further comprise instructions for the processor to seek and receive input from the client device 110, such as via the user interface on the client device 110, regarding the parameters of the reconfigured token(s), such as if user agrees or approves of the represented resource value of each reconfigured token, how often they are to be transferred, when they are to be transferred etc., and if the user would like to modify the reconfigured token parameters. The reversed transfers may then be performed following receipt of user approval.

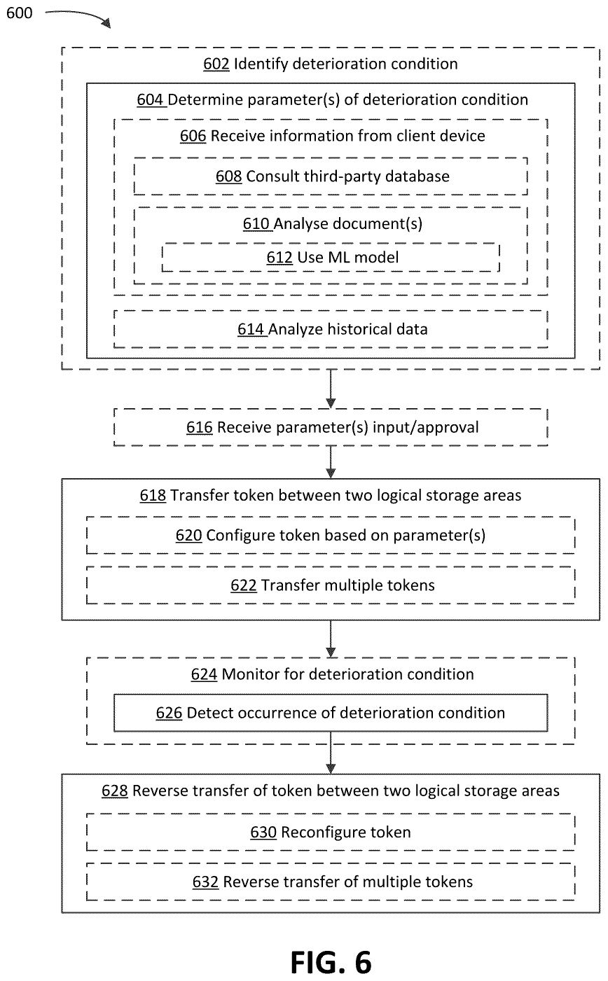

Reference will now be made to FIG. 6, which shows, in flowchart form, an example method 600 for determining a deterioration condition and related parameters associated with a first logical storage area, transferring a token from the first logical storage area to a second logical storage area, monitoring for the occurrence of the deterioration condition, and reversing the transfer of the token. The method 600 may be implemented by way of suitably programmed processor-executable instructions stored in memory that, when executed, cause a computing device to carry out the described functions as described above. As other examples, the method 600 may be performed by another computing system, a software application, a server, a cloud platform, a combination of systems, and the like.

At operation 602, the method 600 may include identifying a deterioration condition. The deterioration condition may in in relation to a particular storage area, such as the first logical storage area (which may be a short-term storage account). In other implementations, the deterioration condition may be in relation to a different storage area. A deterioration condition may be a (future) circumstance that will result in a shortage of a resource for the user. The deterioration condition may result from a decrease in resource input and/or an increase in resource use or output for a particular storage area. At operation 604, the method 600 further includes determining one or more parameters of the deterioration condition. The one or more parameters associated with the identified deterioration may include an expected resource shortage amount upon the occurrence of the deterioration condition, an expected period of time from the current date until the occurrence of the deterioration condition, and an expected duration of the deterioration condition. The parameters may alternatively or additionally include information or data that may be processed to determine the one or more parameters of the deterioration condition.

While the operations 602 and 604 are discussed as separate operations of the method 600, in other implementations, they may be one operation.

In an example implementation, at operation 606, the deterioration condition may be identified by simply receiving input from the client device 110 in the form of data or information, such as via a user interface on the client device 110. In a similar manner, the associated parameters of the deterioration condition may be determined by receiving further information input from the client device 110, indicating what the parameters are.

In another implementation, the information from the client device 110 may be less direct and may be information or data regarding the deterioration condition. Thus, operation 604 may involve processing the received information, such as calculating the one or more parameters of the deterioration condition from the received data. For example, if the received data includes a percentage decrease in the resource starting on a future date, the expected resource shortage amount and the expected period of time until the deterioration condition may be calculated from the percentage decrease, current resource amount, the future date, and the current date. Other variations are possible.

In another implementation, at operation 608, processing the received information/data may involve consulting an internal or third-party database based on the received data in order to determine the parameters of the deterioration condition. For example, if the provider of the resource to the user's account(s) on the computer system 120 is a third-party entity, the deterioration condition information from the client device 110 may be regarding the user's change in status with the third-party entity. In such a case, operation 608 may involve querying the third-party entity or consulting a database of the third-party entity.

In a further implementation, the information pertaining to the deterioration condition may be contained within one or more inputted documents. Thus, at operation 610, the one or more documents may be analysed to obtain the information pertaining to the deterioration condition, and to determine the one or more parameters from that information. At operation 612, a software tool or a machine learning model that is trained to “read” the one or more documents, such as by using optical character recognition, may be used to obtain the relevant information pertaining to the deterioration condition from the inputted documents. The ML model may have been trained to recognize text in a document and identify key information, such as dates or rates pertaining to the deterioration condition, in the text. The ML model may be a trained neural network, a trained deep neural network (DNN), or a trained convolutional neural network (CNN). Once extracted, the extracted information may be additionally processed as discussed above.

In a further implementation, at operation 614, historical data associated with the user's account(s), such as the first logical storage area or the short-term storage account, may be analyzed to identify the deterioration condition and/or the parameters of the deterioration condition. For example, the historical data associated with the first logical storage area may be summarized and compared to predetermined thresholds in order to identify a recurring deterioration condition that has occurred in the past and its associated parameters (such as the past resource shortage, when the past resource shortage occurred, and/or its duration).

Alternatively, a software tool or machine learning model trained to process the historical data may be used to determine the existence of a recurring past deterioration condition and parameters of, or relevant information pertaining to, the recurring past deterioration condition. This ML model may be another ML model that has been trained to process the historical data (including past input/output of resources) and determine the existence of the past deterioration condition and parameters of, or relevant information pertaining to, the past deterioration condition.

At operation 616, the method 600 may include seeking and receiving approval and/or input, such as via the user interface on the client device 110, regarding the identified deterioration condition and associated parameters, such as if they are correct, if they need modification, and what those modifications should be.

After determining the deterioration condition and associated parameters, at operation 618, a token is transferred between the two logical storage areas based on the one or more parameters. As noted above, a token comprises data that enables the system 100 to perform a computing operation in association with the first or second logical storage area that comprises the token. The token or the data of the token may represent a particular amount of the resource. Thus, in some implementations, transferring the token between the logical storage areas may represent transferring the represented amount of the resource between the logical storage areas. A computing operation may be considered an operation that is performed by the system 100 with the resource represented by the token in the relevant storage area, such as saving a data file (if the resource is cloud storage) or purchasing a product (if the resource is money).

For example, if the deterioration condition is determined at operation 602 to occur in relation to the first logical storage area at a future point in time, the token may be transferred from the first logical storage area to the second logical storage area (such as from the short-term storage account to the long-term storage account). The transfer thereby changes the data associated with the short-term storage account and the data associated with the long-term storage account (including the resources therein). Following the transfer of the token, the computing operation can be performed in association with the second logical storage area that is enabled by the token (where the same computer operation cannot be performed in association with the first logical storage area, as it no longer comprises the token).

Prior to the transfer, operation 618 may include configuring the token based on the deterioration condition parameters (at operation 620). For example, the resource value that the token represents may be configured based on the expected resource shortage amount.

In other implementations, at operation 622, multiple tokens may be transferred through multiple transfers from the first logical storage area to the second logical storage area. In such cases, each token may be configured to represent a portion of the expected resource shortage amount and may be configured to be transferred at periodic points of time prior to the expected date of the occurrence of the deterioration condition. The multiple tokens may collectively represent the expected resource shortage and. As before, each transfer changes the data associated with the short-term storage account and the data associated with the long-term storage account.

Optionally, prior to the transfer(s) at operation 618, the method 600 may include seeking and receiving input from the client or user, such as via the user interface on the client device 110, regarding the parameters of the token(s), such as if user agrees or approves of the represented resource value of each token, how often they are to be transferred, when they are to be transferred etc., and if the user would like to modify the token parameters.

At operation 624, the method 600 may include monitoring for the occurrence of the deterioration condition, based on the identified deterioration condition and the determined associated parameters. In applications where the expected period of time until the occurrence of the deterioration condition has been determined at operation 604, the monitoring may simply comprise monitoring for the passing of the expected period of time. In applications where the expected period of time until the occurrence of the deterioration condition depends on a particular change in the first and/or second logical storage area, the activity of the first and/or second logical storage area in order to identify the requisite change. At operation 626, the occurrence of the deterioration condition is detected.

At operation 628, the token(s) are transferred again, where the direction of the transfer(s) is/are reversed. This enables the computing operation to be performed in association with the other one of the two logical storage areas that now comprises the token. In the implementations where the token was initially transferred from the first logical storage area to the second logical storage area, the token is now transferred from the second logical storage area to the first logical storage area (such as from the long-term storage account to the short-term storage account). The reversed transfer also changes the data associated with the short-term storage account and the data associated with the long-term storage account (including the resources therein). Following the reversed transfer of the token, the computing operation can be performed in association with the first logical storage area that is enabled by the token (where the same computer operation cannot be performed in association with the second logical storage area, as it no longer comprises the token).

While the amount represented by the token may be the same for operations 618 and 628, the amount may be reconfigured to a different amount at operation 630. As well, at operation 632, multiple reconfigured tokens may be transferred from the second logical storage area to the first logical storage area.

The methods described herein may be modified and/or operations of such methods combined to provide other methods.

One advantage of the above systems and methods is that they help to strategically move tokens (representing resources) between storage areas in order to help a user pre-emptively save resources prior to an expected resource shortage. Upon occurrence of the resource shortage, the transferred tokens or resources are moved back into the original storage area to help mitigate or overcome the resource shortage. This helps the user to transition through the resource shortage more efficiently, as moving resources from a day-to-day use or short-term storage area helps to prevent those resources from being (inadvertently) used prior to the occurrence of the deterioration condition (i.e. forced savings). This may improve computer operations by helping to prevent the user from entering into, and/or operating in, a deficit situation when the deterioration condition occurs. When the user attempts to perform computer operations with insufficient resources, this often requires the use of additional resources to recover from the deficit, thereby wasting those additional resources.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computing system, comprising:
a processor;
a memory coupled to the processor, the memory storing computer-executable instructions that, when executed by the processor, configure the processor to:
determine one or more parameters of a deterioration condition at a future point in time;
transfer a token between two logical storage areas based on the one or more parameters, the token including data that enables the computer system to perform a computing operation in association with one of the two logical storage areas that comprises the token;
monitor for occurrence of the deterioration condition; and
in response to detecting the occurrence of the deterioration condition, reverse a direction of the transfer of the token to enable the computer system to perform the computing operation in association with another one of the two logical storage areas that now comprises the token.

2. The system of claim 1, wherein the two logical storage areas comprise a first logical storage area and a second logical storage area, the deterioration condition being associated with the first logical storage area, and wherein the transfer occurs from the first logical storage area to the second logical storage area, and the reversed transfer occurs from the second logical storage area to the first logical storage area.

3. The system of claim 2, wherein the deterioration condition includes one or more of:
a decrease in input of a resource into the first logical storage area; and
an increase in use of the resource in the first logical storage area.

4. The system of claim 3, wherein the one or more parameters of the deterioration condition include one or more of an expected resource shortage amount in the first logical storage area upon the occurrence of the deterioration condition, an expected period of time until the occurrence of the deterioration condition, and an expected duration of the deterioration condition.

5. The system of claim 4, wherein the instructions, when executed by the processor, further configure the processor to:
configure the token to represent an amount of the resource based on the one or more parameters.

6. The system of claim 5, wherein the instructions, when executed by the processor, further configure the processor to:
periodically transfer further tokens from the first logical storage area to the second logical storage area based on the one or more parameters, the further tokens including data that enables the computer system to perform computing operations in association with the second logical storage area that comprises the further tokens; and
in response to detecting the occurrence of the deterioration condition, reverse the transfer of the further tokens to enable the computer system to perform the computing operations in association with the first logical storage area that now comprises the further tokens.

7. The system of claim 6, wherein the instructions, when executed by the processor, further configure the processor to:
configure the token and the further tokens to collectively represent the expected resource shortage amount.

8. The system of claim 7, wherein the instructions, when executed by the processor, configure the processor to determine the one or more parameters of the deterioration condition by analyzing historical data in connection with the first logical storage area.

9. The system of claim 8, wherein the instructions, when executed by the processor, further configure the processor to analyze the historical data in connection with the first logical storage area using a trained machine learning model.

10. The system of claim 7, wherein the instructions, when executed by the processor, configure the processor to determine the one or more parameters of the deterioration condition by receiving information regarding the deterioration condition.

11. The system of claim 10, wherein the instructions, when executed by the processor, further configure the processor to determine the one or more parameters of the deterioration condition by consulting third-party data based on the received information.

12. The system of claim 10, wherein the received information is contained within a document associated with the deterioration condition, and the instructions, when executed by the processor, configure the processor to analyse the document to determine the one or more parameters.

13. The system of claim 12, wherein the instructions, when executed by the processor, further configure the processor to analyse the document to obtain the received information using a trained machine learning model.

14. The system of claim 7, wherein the instructions, when executed by the processor, further configure the processor to:
in response to detecting the occurrence of the deterioration condition, reconfigure each token to represent another amount of the resource based on the one or more parameters.

15. The system of claim 1, wherein the instructions, when executed by the processor, further configure the processor to obtain approval for the one or more parameters of the deterioration condition and/or for the transfer of the token between the two logical storage areas prior to the transfer.

16. A computer-implemented method comprising:
determining one or more parameters of a deterioration condition at a future point in time;
transferring a token between two logical storage areas based on the one or more parameters, the token including data that enables a computer system to perform a computing operation in association with one of the two logical storage areas that comprises the token;
monitoring for occurrence of the deterioration condition; and
in response to detecting the occurrence of the deterioration condition, reversing a direction of the transfer of the token to enable the computer system to perform the computing operation in association with the other one of the two logical storage areas that now comprises the token.

17. The method of claim 16, wherein the one or more parameters of the deterioration condition include one or more of an expected shortage amount of a resource in a first logical storage area of the two logical storage areas upon the occurrence of the deterioration condition, an expected period of time until the occurrence of the deterioration condition, and an expected duration of the deterioration condition.

18. The method of claim 17, further comprising:
periodically transferring further tokens from the first logical storage area to a second logical storage area based on the one or more parameters, the tokens including data that enables the computer system to perform computing operations in association with the second logical storage area that comprises the further tokens; and
in response to detecting the occurrence of the deterioration condition, further reversing the transfer of the tokens to enable the computer system to perform the computing operations in association with the first logical storage area that now comprises the tokens.

19. The method of claim 18, further comprising:
configuring the token and the further tokens to collectively represent the expected shortage amount of the resource.

20. The method of claim 19, wherein determining the one or more parameters of the deterioration condition comprises analyzing historical data in connection with the first logical storage area with a trained machine learning model.
